(19) United States
(12) Patent Application Publication
(10) Pub. No.: US 2026/0186294 A1
(43) Pub. Date: Jul. 2, 2026

(54) LENS ASSEMBLY

(71) Applicant: SAMSUNG ELECTRO-MECHANICS CO., LTD., Suwon-si (KR)

(72) Inventors: Seong Chan PARK, Suwon-si (KR); Sang Hyun KWON, Suwon-si (KR); Su Min KANG, Suwon-si (KR); Seung Mi LEE, Suwon-si (KR); Jung Eun NOH, Suwon-si (KR); Yee Na SHIN, Suwon-si (KR); Seon Ki KIM, Suwon-si (KR); Hyun Joong LEE, Suwon-si (KR)

(73) Assignee: SAMSUNG ELECTRO-MECHANICS CO., LTD., Suwon-si (KR)

(21) Appl. No.: 19/331,257

(22) Filed: Sep. 17, 2025

(30) Foreign Application Priority Data
Dec. 27, 2024 (KR) 10-2024-0198972

(51) Int. Cl. G02B 27/00; G02B 7/02

(52) U.S. Cl. CPC G02B 27/0006; G02B 7/021

(57) ABSTRACT

A lens assembly is provided. The lens assembly includes a lens barrel, a plurality of lenses disposed in the lens barrel along an optical axis, and a spacer disposed between lenses among the plurality of lenses. The spacer includes a plurality of crystal grains and a plurality of pores. The plurality of crystal grains include at least one of aluminum oxide (Al₂O₃), titanium oxide (TiO₂), silicon oxide (SiO₂), and zirconium oxide (ZrO₂).

### CROSS-REFERENCE TO RELATED APPLICATIONS

This application claims the benefit under 35 USC § 119(a) of Korean Patent Application No. 10-2024-0198972 filed on Dec. 27, 2024, in the Korean Intellectual Property Office, the entire disclosure of which is incorporated herein by reference for all purposes.

### BACKGROUND

### 1. Field

The following description relates to a lens assembly.

### 2. Description of Related Art

Recently, camera modules have been implemented in portable electronic devices such as, but not limited to, smartphones.

A camera module may include a lens assembly including a plurality of lenses. In order to improve the performance of the camera module, the number of lenses included in the camera module has increased, and the form factor of the camera module has been reduced in size.

It may be desirous that automotive camera modules have a high reliability so as to operate without issues even under environmental changes such as varying weather conditions. In particular, a condensation phenomenon may occur in a lens of a camera module due to rapid temperature changes or high-humidity environments, which may degrade the reliability of the camera module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a lens assembly includes a lens barrel; a plurality of lenses disposed in the lens barrel along an optical axis; and a spacer disposed between lenses among the plurality of lenses, wherein the spacer comprises a plurality of crystal grains and a plurality of pores, and wherein the plurality of crystal grains comprise at least one of aluminum oxide (Al₂O₃), titanium oxide (TiO₂), silicon oxide (SiO₂), and zirconium oxide (ZrO₂).

The plurality of pores may be disposed between the plurality of crystal grains.

An average diameter of the plurality of pores may be greater than 0 nm and equal to or less than 100 nm.

When a volume occupied by the plurality of pores is defined as Vp, and a volume of the spacer is defined as Vt, Vp/Vt may be 0.2 or more and 0.65 or less.

The spacer may include a first layer and a second layer disposed on the first layer in a direction perpendicular to an optical axis direction, and an average diameter of a plurality of crystal grains of the first layer may be less than an average diameter of a plurality of crystal grains of the second layer.

The first layer may be disposed to be closer to a surface of the spacer than the second layer.

An average diameter of a plurality of pores of the first layer may be less than an average diameter of a plurality of pores of the second layer.

The spacer further may include an intermediate layer disposed between the first layer and the second layer, an average diameter of a plurality of crystal grains of the intermediate layer may be greater than the average diameter of the plurality of crystal grains of the first layer, and the average diameter of the plurality of crystal grains of the intermediate layer may be less than the average diameter of the plurality of crystal grains of the second layer.

An average diameter of a plurality of pores of the intermediate layer may be greater than an average diameter of a plurality of pores of the first layer, and the average diameter of the plurality of pores of the intermediate layer may be less than an average diameter of a plurality of pores of the second layer.

A coating layer may be disposed on a surface of the spacer, and the coating layer may have at least one functional group selected from a hydroxyl group and an amino group.

The coating layer may include amino propyltriethoxysilane (APTEOS).

In a general aspect, a lens assembly includes a lens barrel; a plurality of lenses disposed in the lens barrel along an optical axis; and a spacer disposed between lenses among the plurality of lenses, the spacer comprising a plurality of crystal grains and a plurality of pores, wherein the spacer comprises a first layer and a second layer disposed on the first layer in a direction perpendicular to an optical axis direction, wherein the first layer is disposed to be closer to a surface of the spacer than the second layer, and wherein an average diameter of a plurality of pores of the first layer is less than an average diameter of a plurality of pores of the second layer.

An average diameter of a plurality of crystal grains of the first layer may be less than an average diameter of a plurality of crystal grains of the second layer.

A coating layer may be disposed on a surface of the spacer, and the coating layer may have at least one functional group selected from a hydroxyl group and an amino group.

The coating layer may include aminopropyltriethoxysilane (APTEOS).

Other features and aspects will be apparent from the following detailed description, the drawings, and the claims.

### BRIEF DESCRIPTION OF DRAWINGS

FIG. 1 illustrates a schematic cross-sectional view of an example lens assembly, in accordance with one or more embodiments.

FIG. 2 illustrates a spacer of an example lens assembly, in accordance with one or more embodiments.

FIG. 3 illustrates a cross-sectional view taken along I-I′ of FIG. 2.

FIG. 4 illustrates an enlarged view of portion “A” of FIG. 3.

FIG. 5 illustrates a cross-sectional view of a spacer in an example lens assembly, in accordance with one or more embodiments.

FIGS. 6A, 6B, and 6C illustrate crystal structures of respective layers in FIG. 5.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more embodiments may provide a lens assembly that prevents condensation of water vapor on lenses.

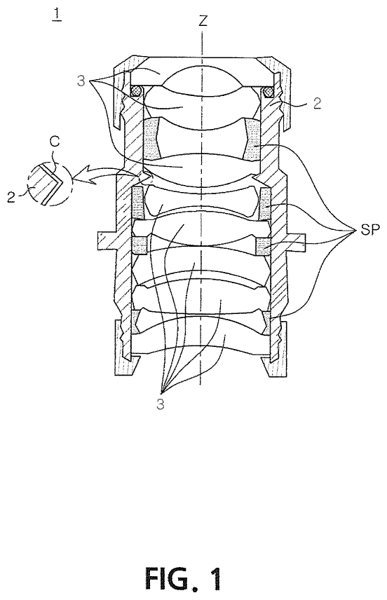

FIG. 1 illustrates a schematic cross-sectional view of an example lens assembly, in accordance with one or more embodiments.

Referring to FIG. 1, a lens assembly 1, in accordance with one or more embodiments, may include a lens barrel 2 and a plurality of lenses 3 disposed in the lens barrel 2. A spacer SP may be provided between lenses among the plurality of lenses 3.

The lens assembly 1 may include at least two lenses 3 disposed in the lens barrel 2 along an optical axis Z, and a spacer SP may be provided between the at least two lenses 3. In the present example embodiment, for example, a structure including eight lenses is presented. However, this structure is merely an example, and a lens assembly including at least two lenses may be included within the scope of the example embodiments.

The lens barrel 2 may have a hollow cylindrical shape such that a plurality of lenses 3, that capture an image of a subject, are accommodated therein. The plurality of lenses 3 may be mounted in the lens barrel 2 along the optical axis. In an example, the lens barrel 2 may be formed of polycarbonate.

The lens assembly 1 according to an example embodiment may include a spacer SP provided between the lenses 3. The spacer SP may be configured to maintain a constant interval between two adjacent lenses 3. In optical system design, the interval between the lenses 3 may be a major factor that affects image quality, and the spacer SP may allow adjacent lenses of the plurality of lenses 3 to be spaced apart from each other at a predetermined interval.

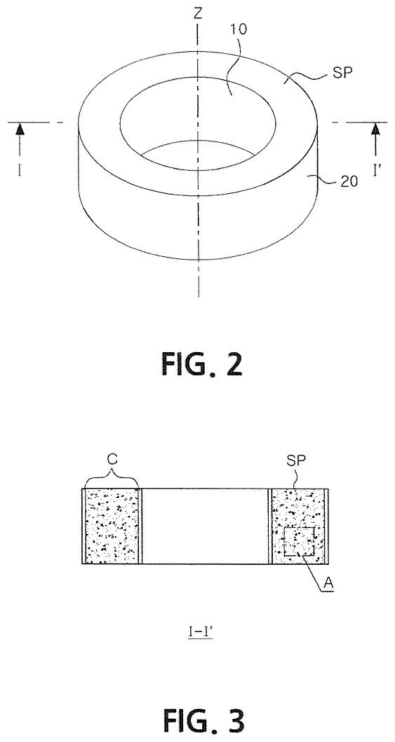

FIG. 2 is a diagram illustrating a spacer SP of a lens assembly, in accordance with one or more embodiments. FIG. 3 is a cross-sectional view taken along I-I′ of FIG. 2.

Referring to FIGS. 2 and 3, the spacer SP may have an internal surface 10 that forms an opening, and an external surface 20 opposing the lens barrel. The internal surface 10 of the spacer SP may have an opening through which light passes. That is, a space surrounded by the internal surface 10 of the spacer SP body may define the opening. In an example, the internal surface 10 of the spacer, an inner wall formed to surround a center of the opening, may refer to a surface provided to oppose a direction perpendicular to a direction in which light passes through (optical axis direction). That is, the internal surface 10 of the spacer may refer to an internal surface of a body of the spacer SP having a ring shape.

The spacer SP may be configured to block a portion of light passing through one side of each of the plurality of lenses 3. The spacer SP may prevent or minimize a flare phenomenon by blocking a portion of light.

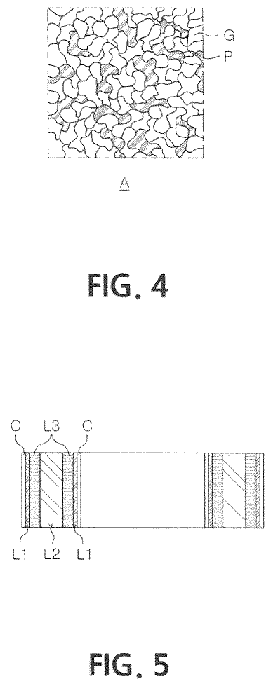

FIG. 4 illustrates an enlarged view of portion “A” of FIG. 3.

Referring to FIG. 4, the spacer SP may include a plurality of crystal grains G and a plurality of pores P. The plurality of crystal grains G may include at least one of aluminum oxide (Al₂O₃), titanium oxide (TiO₂), silicon oxide (SiO₂), and zirconium oxide (ZrO₂). Specifically, the plurality of crystal grains G may include at least one of Al₂O₃, TiO₂, SiO₂, and ZrO₂. In the related art, a spacer may be formed of a metal material, for example, a non-ferrous metal material. For example, the spacer may be formed of a phosphor bronze material. The spacer SP of the lens assembly according to the present example embodiment may be formed of ceramic having a porous structure. That is, the lens assembly according to the present example embodiment may include a spacer SP formed of a porous moisture-absorbing material to prevent condensation of water vapor in the assembly. The spacer SP formed of the porous moisture-absorbing material may perform a moisture-absorbing action under rapid temperature changes or high humidity conditions caused by an external environment, thereby suppressing a condensation phenomenon and a dew phenomenon of moisture occurring in the lens assembly. The spacer SP may be formed by mixing ceramic powder particles with a binder, a solvent, and the like, molding and drying a mixture to fix a shape thereof, and then sintering at a high temperature of 800° C. or higher.

The plurality of pores P may be formed between the plurality of crystal grains. The plurality of pores P may be formed in a portion of the spacer from which a binder or the like is removed, and an average diameter of the plurality of pores P may be greater than 0 nm and less than or equal to 100 nm. The plurality of pores P may be formed on a nanometer scale, such that water molecules may be physically adsorbed into nanometer-sized pores. Additionally, water molecules may be effectively captured through a capillary condensation mechanism or the like. When the average diameter of the plurality of pores P is greater than 100 nm, surface areas of the pores may decrease, such that water molecules may be more likely to evaporate or leak from inside the pores, which may degrade the moisture absorption performance of the spacer SP. However, the one or more examples are not limited thereto. As in a modification to be described below, a pore size may be formed to be greater than 100 nm depending on a layer of the spacer.

When a volume occupied by the plurality of pores P is defined as Vp, and a volume of the spacer SP is defined as Vt, a porosity of the material of the spacer, that is, (Vp/Vt)×100%, may be 20% or more and 65% or less. Vt may refer to an external volume of a material including the volume of the plurality of pores. When the porosity is less than 20%, the pore volume may be insufficient, thereby limiting an amount of water molecules that may be absorbed, which may degrade the moisture absorption performance of the spacer. When the porosity of the material of the spacer is greater than 65%, pore volume may excessively increase, resulting in an increase in connectivity between pores, thereby reducing the structural stability and mechanical strength of the spacer.

A diameter of each of the plurality of pores P and the plurality of crystal grains G according to the present example embodiment may be measured by analyzing a high-magnification image scanned using a scanning electron microscope (SEM). A detailed method may be as follows. A sample having a porous ceramic structure may be cut into a cross-sectional shape and processed into a form suitable for SEM analysis. A Feret diameter, representing a maximum diameter of each pore and each crystal grain, may be measured. A particle size analysis software may be used for the measurement, and an average value may be calculated based on data obtained by measuring the Feret diameters of the plurality of pores and crystal grains.

The porosity may be measured using a bulk density (ρ_{bulk}) and a true density (ρₜᵣᵤₑ), and may be calculated as follows.

$$Porosity ( \% ) = ( 1 - {ρ}_{bulk} / {ρ}_{true} ) \times 100 \qquad Equation 1$$

The bulk density (ρ_{bulk}) may refer to a mass relative to a total volume of a sample. The bulk density (ρ_{bulk}) may be measured using the Archimedes method or a geometrical method.

The true density (ρₜᵣᵤₑ) may refer to a density of a material excluding pores. The true density (ρₜᵣᵤₑ) may be measured using helium pycnometry, or a standard density value of the material may be used.

The lens assembly according to the present example embodiment may include a coating layer C disposed on a surface of the spacer SP or a surface of the lens barrel 2.

Referring to FIG. 3, the coating layer C may be disposed on an internal surface of the spacer SP or an external surface of the spacer SP.

Referring to FIG. 1, the coating layer C may be disposed on a surface of the lens barrel 2. Specifically, the coating layer C may be disposed on an internal surface of the lens barrel 2 on which the lens 3 is disposed.

The coating layer C may include at least one functional group selected from a hydroxyl group (—OH) and an amino group (—NH₂). The hydroxyl group and the amino group may enhance the moisture absorption performance of the spacer SP through interaction with water molecules. For example, the coating layer C may include aminopropyltriethoxysilane (APTEOS). Aminopropyltriethoxysilane (APTEOS) may include an amino group and a siloxane group. The amino group may provide hydrophilicity to a surface of the spacer SP (or the lens barrel 2), and the siloxane group may bond to the surface of the spacer SP (or the lens barrel 2) to form a robust coating layer.

The coating layer may be formed to have a thickness of 10 nm to 500 nm through a process such as atomic layer deposition (ALD), molecular vapor deposition (MVD), spraying, dipping, or UV treatment, as only examples. A hydrophilic coating including a specific functional group may be applied to a surface of a porous moisture-absorbing material, thereby improving the moisture absorption performance of the spacer SP and optimizing moisture management in the lens assembly.

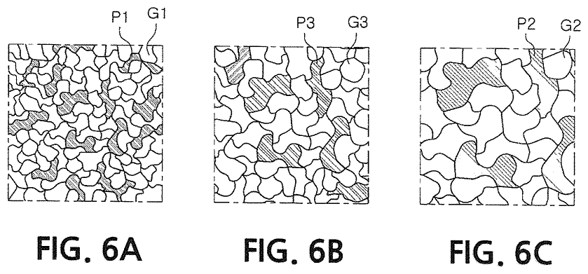

FIG. 5 is a cross-sectional view of a spacer in a lens assembly according to a modification of the one or more examples. FIGS. 6A, 6B, and 6C illustrate crystal structures of respective layers illustrated in FIG. 5. FIGS. 6A, 6B, and 6C respectively illustrate crystal structures of a first layer L1, an intermediate layer L3, and a second layer L2.

Referring to FIG. 5, a spacer SP, according to a modification, may have a plurality of layers in a direction, perpendicular to an optical axis direction. Specifically, the spacer may include a first layer L1, an intermediate layer L3, and a second layer L2, which may be disposed in the order of the first layer L1, the intermediate layer L3, and the second layer L2 in the direction, perpendicular to the optical axis direction. Each of the respective layers L1, L2, and L3 may respectively include a plurality of crystal grains G1, G2, and G3, and a plurality of pores P1, P2, and P3 formed between the plurality of crystal grains.

Hereinafter, for ease of description, the plurality of crystal grains G1 of the first layer L1 may be referred to as first crystal grains G1, the plurality of crystal grains G2 of the second layer L2 may be referred to as second crystal grains G2, and the plurality of crystal grains G3 of the intermediate layer L3 may be referred to as third crystal grains G3. Similarly, the plurality of pores P1 formed between the first crystal grains G1 may be referred to as first pores P1, the plurality of pores P2 formed between the second crystal grains G2 may be referred to as second pores P2, and the plurality of pores P3 formed between the third crystal grains G3 may be referred to as third pores P3.

An average diameter of the first crystal grains G1 may be less than an average diameter of the second crystal grains G2. The first layer L1 may be disposed to be closer to an internal surface or external surface of the spacer SP than the second layer L2. That is, the spacer SP may include a plurality of layers having different crystal grain sizes, and the first layer L1 having smaller crystal grains may be disposed to be closer to an external surface (or an internal surface) of the spacer SP to increase moisture absorption performance. Additionally, the second layer L2 having larger crystal grains than the first crystal grains G1 may be disposed in the spacer SP to provide structural strength and ensure mechanical support.

An average diameter of the first pores P1 may be less than an average diameter of the second pores P2. For example, the first pores P1 may have an average diameter of 0.05 μm or more and less than 1 μm, and the second pores P2 may have an average diameter of 5 μm or more. The first pores P1 may induce strong physical adsorption of water molecules, and the second pores P2 may facilitate the collection of a large amount of moisture.

The average diameters of the first pores P1 and the second pores P2 may be measured as follows. First, a sample having the porous ceramic structure may be cut into a cross-sectional shape and processed to a form suitable for SEM analysis. The first layer L1 may be disposed to be closer to an internal surface or an external surface of the spacer SP than the second layer L2, and thus a first point and a second point, spaced apart from each other in a direction, perpendicular to an optical axis (Z), may be selected to calculate an average diameter of pores at each point. For example, the first point may correspond to a depth of 1/100 from the external surface of the spacer, and the second point may correspond to a depth of ½ from the external surface of the spacer. However, the one or more examples are not limited thereto.

Additionally, each of the first point and the second point may refer to a plurality of points (for example, five points) spaced apart from each other at equal intervals in a direction, parallel to the optical axis (Z), in the cross-sectional sample. Accordingly, an average value of diameters of pores may be calculated at each of a plurality of first points, spaced apart from each other at equal intervals, and a plurality of second points, spaced apart from each other at equal intervals.

In the case of measuring average diameters of the crystal grains G1 and G2, a similar method may be applied, and a detailed description thereof is omitted herein to avoid redundancy.

The intermediate layer L3 may be disposed between the first layer L1 and the second layer L2 of the spacer SP. An average diameter of the third crystal grains G3 may be greater than the average diameter of the first crystal grains G1 and less than the average diameter of the second crystal grains G2. The diameters of the crystal grains may gradually increase in the order of the first layer L1, the intermediate layer L3, and the second layer L2, thereby improving bonding stability between the layers and improving resistance to thermal and mechanical impacts.

The average diameter of the third pores P3 may be greater than the average diameter of the first pores P1 and less than the average diameter of the second pores P2. In an example, the third pores P3 may have an average diameter of 1 μm or more and less than 5 μm. The third pores P3 may expand a travel path of substances and prevent damage to a membrane layer.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A lens assembly, comprising:
a lens barrel;
a plurality of lenses disposed in the lens barrel along an optical axis; and
a spacer disposed between lenses among the plurality of lenses,
wherein the spacer comprises a plurality of crystal grains and a plurality of pores, and
wherein the plurality of crystal grains comprise at least one of aluminum oxide (Al₂O₃), titanium oxide (TiO₂), silicon oxide (SiO₂), and zirconium oxide (ZrO₂).

2. The lens assembly of claim 1, wherein the plurality of pores are disposed between the plurality of crystal grains.

3. The lens assembly of claim 1, wherein an average diameter of the plurality of pores is greater than 0 nm and equal to or less than 100 nm.

4. The lens assembly of claim 1, wherein, when a volume occupied by the plurality of pores is defined as Vp, and a volume of the spacer is defined as Vt, Vp/Vt is 0.2 or more and 0.65 or less.

5. The lens assembly of claim 1, wherein:
the spacer comprises a first layer and a second layer disposed on the first layer in a direction perpendicular to an optical axis direction, and
an average diameter of a plurality of crystal grains of the first layer is less than an average diameter of a plurality of crystal grains of the second layer.

6. The lens assembly of claim 5, wherein the first layer is disposed to be closer to a surface of the spacer than the second layer.

7. The lens assembly of claim 5, wherein an average diameter of a plurality of pores of the first layer is less than an average diameter of a plurality of pores of the second layer.

8. The lens assembly of claim 5, wherein:
the spacer further comprises an intermediate layer disposed between the first layer and the second layer,
an average diameter of a plurality of crystal grains of the intermediate layer is greater than the average diameter of the plurality of crystal grains of the first layer, and
the average diameter of the plurality of crystal grains of the intermediate layer is less than the average diameter of the plurality of crystal grains of the second layer.

9. The lens assembly of claim 8, wherein:
an average diameter of a plurality of pores of the intermediate layer is greater than an average diameter of a plurality of pores of the first layer, and
the average diameter of the plurality of pores of the intermediate layer is less than an average diameter of a plurality of pores of the second layer.

10. The lens assembly of claim 1, wherein:
a coating layer is disposed on a surface of the spacer, and
the coating layer has at least one functional group selected from a hydroxyl group and an amino group.

11. The lens assembly of claim 10, wherein the coating layer comprises amino propyltriethoxysilane (APTEOS).

12. A lens assembly, comprising:
a lens barrel;
a plurality of lenses disposed in the lens barrel along an optical axis; and
a spacer disposed between lenses among the plurality of lenses, the spacer comprising a plurality of crystal grains and a plurality of pores,
wherein the spacer comprises a first layer and a second layer disposed on the first layer in a direction perpendicular to an optical axis direction,
wherein the first layer is disposed to be closer to a surface of the spacer than the second layer, and
wherein an average diameter of a plurality of pores of the first layer is less than an average diameter of a plurality of pores of the second layer.

13. The lens assembly of claim 12, wherein an average diameter of a plurality of crystal grains of the first layer is less than an average diameter of a plurality of crystal grains of the second layer.

14. The lens assembly of claim 12, wherein:
a coating layer is disposed on a surface of the spacer, and
the coating layer has at least one functional group selected from a hydroxyl group and an amino group.

15. The lens assembly of claim 14, wherein the coating layer comprises aminopropyltriethoxysilane (APTEOS).
